(19) United States
(12) Patent Application Publication
(10) Pub. No.: US 2026/0296097 A1
(43) Pub. Date: Oct. 1, 2026

(54) Paint-Return Paint Can Device

(71) Applicant: Christian Elia, Stockton, CA (US)

(72) Inventor: Christian Elia, Stockton, CA (US)

(21) Appl. No.: 19/257,584

(22) Filed: Jul. 2, 2025

Related U.S. Application Data
(60) Provisional application No. 63/781,470, filed on Apr. 1, 2025.

(51) Int. Cl. B44D 3/12

(52) U.S. Cl. CPC B44D 3/128

(57) ABSTRACT

A paint-return paint can device is provided. The device is comprised of a container body having an interior space adapted to hold fluid substances, including paint, primer, or sealant. The container body comprises a rim integrated with at least one paint-removing member configured to remove excess coating from a paintbrush and guide said coating back into the interior space. The paint-removing member may include brush-engaging surfaces such as ridges or angular protrusions sloped downward toward the center of the container to assist gravitational flow of excess paint. These members may be integrally formed or removably attached using male fasteners engaged within corresponding engagement channels along the rim. The lid of the device is further formed with receiving areas to accommodate the contour of the paint-removing members and features male fasteners that engage the rim's channels for a secure, low-splatter seal.

### CROSS-REFERENCE TO RELATED APPLICATION

The present application claims priority to, and the benefit of, U.S. Provisional Application No. 63/781,470, which was filed on Apr. 1, 2025, and is incorporated herein by reference in its entirety.

### FIELD OF THE INVENTION

The present invention relates generally to the field of paint cans. More specifically, the present invention relates to a paint can with a rim featuring at least one paint-removing member configured to strip excess material from a brush and direct said material back into the container. The device further includes a lid with receiving areas and fasteners that align with the rim and paint-removing members to create a secure, low-splatter seal. Accordingly, the present disclosure makes specific reference thereto. Nonetheless, it is to be appreciated that aspects of the present invention are also equally applicable to other like applications, devices, and methods of manufacture.

### BACKGROUND

Conventional paint cans present several functional challenges during use, particularly when transferring paint or managing excess material on brushes. More specifically, when paint is poured from a typical can, liquid often drips along the outer surface, causing staining on floors and surrounding areas. This problem frequently arises in both residential and professional settings, necessitating time-consuming cleanup and increasing material waste. Similarly, users commonly remove excess paint from brushes by wiping them against the rim of the can, which results in pooling and spillage over the edges. The repetitive impact of this practice can also deform the rim, leading to further leakage and compromised sealing when reapplying the lid. Additionally, the process of resealing paint cans with a hammer often causes residual paint to splatter outward, posing additional risks to cleanliness and user safety. Attempts to mitigate these issues using secondary accessories or after-market tools are often incompatible with standard cans, difficult to clean, or non-durable. These shortcomings create inefficiencies in common painting workflows, generating a need for an integrated, reusable, and effective solution that addresses spillage, brush-cleaning, and lid reapplication in a cohesive manner.

Therefore, there exists a long-felt need in the art for a paint-return paint can device that reduces paint dripping and spillage when pouring or wiping brushes. There also exists a long-felt need in the art for a paint-return paint can device that enables efficient redirection of excess paint back into the container. Moreover, there exists a long-felt need in the art for a paint-return paint can device that prevents splattering during lid application.

The subject matter disclosed and claimed herein, in one embodiment thereof, comprises a paint-return paint can device. The device is comprised of a container body having an interior space adapted to hold fluid substances, including paint, primer, or sealant. The container body comprises a rim integrated with at least one paint-removing member configured to remove excess coating from a paintbrush and guide said coating back into the interior space. The paint-removing member may include brush-engaging surfaces such as ridges or angular protrusions sloped downward toward the center of the container to assist gravitational flow of excess paint. These members may be integrally formed or removably attached using male fasteners engaged within corresponding engagement channels along the rim.

In this manner, the paint-return paint can device of the present invention accomplishes all the foregoing objectives and provides a paint can device that minimizes drips and redirects excess fluid efficiently. The inclusion of brush-engaging surfaces and auxiliary flow guides further reduces the accumulation of paint on external surfaces, addressing common cleanup concerns. The secure engagement between the lid and rim mitigates splatter during closure while maintaining a reliable seal. By addressing the problems of spillage, inefficient paint recovery, and messy resealing, the device provides a practical, durable, and adaptable solution suitable for both professional and residential painting applications.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a paint-return paint can device. The device is comprised of a container body that includes an interior space for holding liquid substances such as paint or sealants. The body has a rim further comprised of at least one paint-removing member, which may be in the form of, but not limited to, notches, slots, grooves, or similar structures that are recessed, flush, or protruding from the rim. These members are configured to remove excess material from a paintbrush and return the material to the interior space. In some embodiments, the paint-removing member is raised above the rim and slopes inward or downward toward the interior space. This member includes brush-engaging surfaces such as ridges or fins, which may be sloped and textured to aid in material removal and promote return flow of the fluid. The paint-removing member may also include auxiliary elements such as stipples, dimples, or fluid-directing contours that enhance removal efficiency and minimize pooling or accumulation.

The paint-removing member may be formed integrally with the rim or attached using various bonding or fastening methods. In some configurations, the member is removable and reusable, incorporating fasteners that engage with channels in the rim to allow attachment to standard paint cans.

A handle assembly is included on the container body and is comprised of lugs and a handle formed from various materials. The handle includes a grip area made from non-slip material and may feature ergonomic or textured enhancements.

The invention also includes a method of use involving providing the container body, filling it with liquid, optionally attaching the paint-removing member to an existing container, removing excess material from a brush using the paint-removing member, guiding residual fluid via auxiliary elements, and sealing the container with the lid aligned to accommodate the paint-removing member.

Accordingly, the paint-return paint can device of the present invention is particularly advantageous as it provides a paint can device that minimizes drips and redirects excess fluid efficiently. The inclusion of brush-engaging surfaces and auxiliary flow guides further reduces the accumulation of paint on external surfaces, addressing common cleanup concerns. The secure engagement between the lid and rim mitigates splatter during closure while maintaining a reliable seal. By addressing the problems of spillage, inefficient paint recovery, and messy resealing, the device provides a practical, durable, and adaptable solution suitable for both professional and residential painting applications. In this manner, the paint-return paint can device overcomes the limitations of existing paint can devices and methods of use known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of a paint-return paint can device of the present invention in accordance with the disclosed architecture;

FIG. 2 illustrates a side perspective view of one potential embodiment of a paint-return paint can device of the present invention in accordance with the disclosed architecture; and

FIG. 3 illustrates a flowchart of a method of using one potential embodiment of a paint-return paint can device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a paint-return paint can device that reduces paint dripping and spillage when pouring or wiping brushes. There also exists a long-felt need in the art for a paint-return paint can device that enables efficient redirection of excess paint back into the container. Moreover, there exists a long-felt need in the art for a paint-return paint can device that prevents splattering during lid application.

The present invention, in one exemplary embodiment, is comprised of a paint-return paint can device. The device includes a container body having an interior space designed to hold liquid substances such as paint or sealants. A rim is integrated into the body, which incorporates at least one paint-removing member. This member may take the form of notches, slots, grooves, or similar structures that are recessed, flush with, or protruding from the rim. The members function to remove excess coating from a paintbrush and direct the material back into the interior space. In certain embodiments, the paint-removing member is positioned above the rim and slopes inward or downward toward the interior. The member features brush-engaging surfaces such as ridges or fins that may be sloped and textured to enhance fluid removal and facilitate return flow. Auxiliary elements may also be included on the paint-removing member, such as stipples, dimples, or fluid-directing contours. These additions improve the efficiency of excess material removal and reduce pooling or buildup on the member surface.

The paint-removing member may be formed as an integral part of the rim or may be attached by means of bonding or mechanical fastening techniques. In some embodiments, the member is detachable and reusable, utilizing fasteners that align with engagement channels on the rim, allowing the member to be connected to standard paint cans. The engagement channels on the rim may also serve to secure a lid to the container body. A handle assembly is also featured on the container body, comprising lugs and a handle constructed from various materials. The handle includes a grip area made from non-slip material and may be ergonomically or texturally enhanced for improved handling.

The invention further comprises a method of use involving the steps of providing the container body, introducing liquid into the interior space, optionally attaching the paint-removing member to an existing container, using the member to remove excess coating from a paintbrush, channeling residual fluid via auxiliary features, and aligning and securing the lid over the rim to accommodate the paint-removing member.

As a result, the present paint-return paint can device offers notable advantages by effectively minimizing drips and facilitating the redirection of excess fluid. The integration of brush-engaging and auxiliary flow-guiding features reduces external surface accumulation and simplifies cleanup. Secure lid-to-rim engagement mitigates splatter and maintains sealing integrity. By addressing common issues such as spillage, inefficient recovery, and challenging resealing, the device delivers a practical and versatile solution for both professional and residential painting tasks, surpassing the limitations of conventional paint can devices and methods.

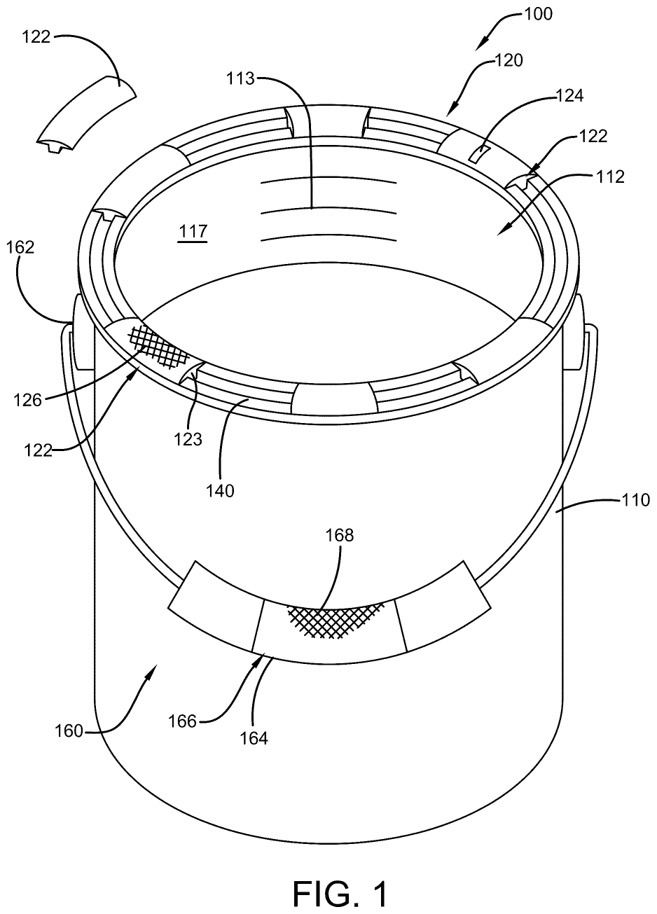

Referring initially to the drawings, FIG. 1 illustrates a front perspective view of one potential embodiment of a paint-return paint can device 100 of the present invention in accordance with the disclosed architecture. The device 100 is comprised of a container body 110. The body 110 may be any shape such as, but not limited to, generally cylindrical, polygonal, conical, stepped, tapered, etc. The body 110 may be formed from materials including, but not limited to, metal, plastic, composites, biodegradable polymers, or multi-layer laminates selected for durability, chemical resistance, or environmental sustainability.

The body 110 is comprised of an interior space 112 designed to hold liquid substances such as paint, primer, wood stain, sealant, or other fluid coatings. The interior space 112 may optionally include volumetric measurement indicators 113 of any unit such as, but not limited to, ounces, milliliters, liters, cups, quarts, percentage fill levels, etc. These indicators 113 may be molded, embossed, printed, or etched onto the interior surface 117 of the container body 110, as seen in FIG. 1.

The container body 110 further includes a rim 120. In various embodiments, the rim 120 may be flat, flared, rounded, stepped, etc. The rim 120 may also be comprised of paint-removing member 122. The paint-removing member 122 may be configured as a continuous or segmented structure that may be in the form of, but is not limited to, a series of notches, slots, cutouts, or grooves distributed around the circumference of the rim 120. The members 122 may be recessed into the rim 120, flush with the rim 120 surface, or protruding from the rim 120, depending on the intended interaction with a user's paintbrush. The geometry of the members 122 may vary, including, but not limited to, V-shaped indentations, rectangular recesses, serrated gaps, arched slits, wave-like contours, etc., each designed to engage the bristles and/or ferrule of a paintbrush and strip excess coating material back into the interior space 112.

In one embodiment, the paint-removing member 122 is raised above the rim 120 and slopes inward and/or downward towards the interior space 112 as seen in FIG. 1. In this embodiment, the member 122 has at least one brush-engaging surface 124 that may take the form of, but not limited to, ridges, fins, blades, or angular protrusions arranged radially, tangentially, or helically on the member 122. The brush-engaging surfaces 124 may be flat, concave, convex, or microtextured. Each surface 124 may be sloped relative to the horizontal axis of the container body 110 at an angle between approximately 1 degrees and 89 degrees. This sloped configuration promotes gravitational return of the excess fluid back into the interior space 112 from the member 122 while facilitating ease of brush contact and reducing dripping onto external surfaces.

To enhance functionality, the paint-removing member 122 may also include an auxiliary paint removal element 126, as seen in FIG. 1. The element 126 may be comprised of, but is not limited to, a surface texturing such as stipples, dimples, cross-hatching, etched microgrooves, molded ribs, raised channels, flexible wiper flaps, or fluid-directing contours such as depressions or ridgelines configured to guide paint back toward the central axis of the container 110. These elements 126 further optimize runoff, reduce paint pooling, and minimize accumulation on the paint-removing member 122 itself.

The paint-removing member 122 may be formed integrally with the rim 120 during manufacturing or may be affixed post-production using adhesive bonding, ultrasonic welding, thermal fusing, or mechanical means. In some embodiments, the member 122 is configured to be attachable and removable from any paint can rim and is reusable, as seen in FIG. 1. For example, the paint-removing member 122 may include a male fastener 123 such as, but not limited to, a tab, locking peg, snap-fit element, or interlocking tongue that inserts into one or more engagement channels 140 located on or within the rim 120. The engagement channels 140 may be uniformly or asymmetrically spaced, and may be in the form of, but not limited to, keyways, sockets, undercut slots, etc. This removability allows for cleaning, replacement, or customization of the paint-removing feature 122, and may further enable the member 122 to be attached to standard paint cans not originally equipped with the same.

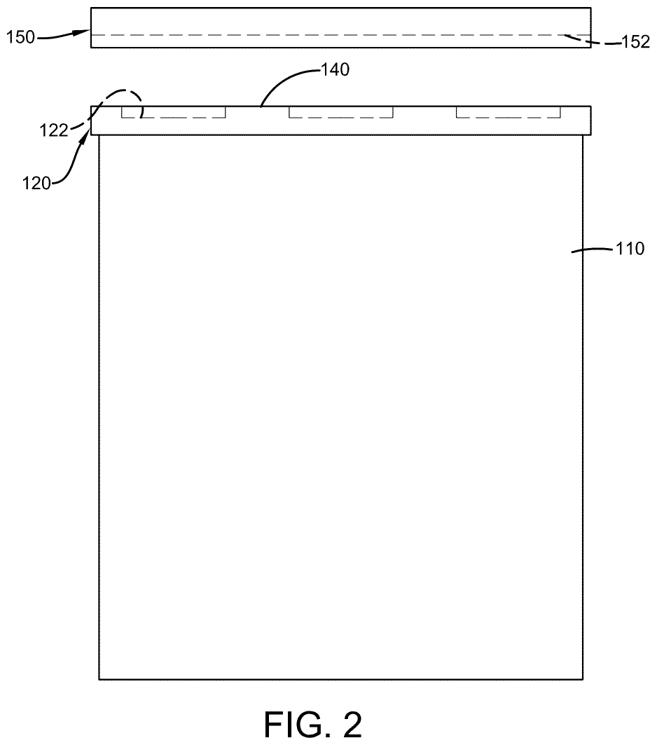

The device 100 is also comprised of a lid 150 that may be made from rigid or semi-flexible materials, including high-impact plastics, elastomers, or lightweight metals, and may feature a domed, recessed, or flat in configuration. The lid 150 may include a series of receiving areas 152 (as seen in FIG. 2) shaped to conform to the contours of the paint-removing members 122 that may be raised, recessed, or otherwise projecting from the rim 120. These receiving areas 152 allow the lid 150 to seat properly over the rim 120 without interference, maintaining an effective seal. This engagement not only facilitates a secure fit of the lid 150 on the container body 110 but also helps distribute compressive forces evenly during lid 150 application, reducing the chance of splatter and ensuring better alignment.

The container body 110 further comprises a handle assembly 160, as seen in FIG. 1. The handle assembly 160 may include opposing lugs 162 that are attached to the side wall 111 of the body, either integrally molded or affixed using rivets, welds, adhesives, etc. A handle 164 attaches to the lugs 162 and may take the form of a wire bail, molded plastic arc, telescoping rod, a reinforced strap, etc., and may be fabricated from metal, plastic, composite, wood, etc. The handle may feature a grip area 166 formed of a non-slip material such as rubber, silicone, textured polymer, or foam, and may additionally or alternatively include a surface texture 168 such as ridges, checkering, or ergonomic indentations.

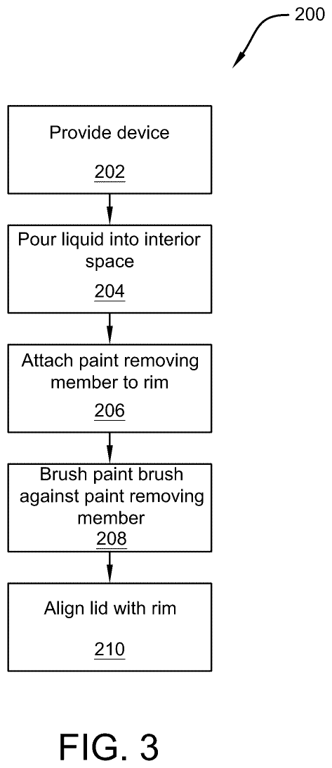

The present invention is also comprised of a method of using 200 the device 100, as seen in FIG. 3. First, a device 100 is provided comprised of a container body 110 having an interior space 112, a rim 120, at least one paint-removing member 122, a lid 150, and a handle assembly 160 [Step 202]. Then, a liquid substance such as, but not limited to, paint, primer, wood stain, sealant, or another fluid coating is poured into the interior space 112 of the container body 110 [Step 204]. Optionally, the paint-removing member 122 may be attached to the rim 120 of an existing paint can by inserting at least one male fastener 123 into one or more engagement channels 140 located on or within the rim 120 in an embodiment that does not include a container body 110 [Step 206]. Next, a paintbrush may be brushed against the paint-removing member 122 by contacting the bristles and/or ferrule with the brush-engaging surfaces 124 of the member 122 to remove excess coating material and return it to the interior space 112 [Step 208]. Then, an auxiliary paint removal element 126 located on the paint-removing member 122 may guide residual fluid toward the central axis of the container body 110 and reduce pooling on the member 122. Next, the lid 150 is aligned with the rim 120 to seal the container body 110 [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “paint-return paint can device” and “device” are interchangeable and refer to the paint-return paint can device 100 of the present invention.

Notwithstanding the foregoing, the paint-return paint can device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the paint-return paint can device 100 as shown in the FIGS. are for illustrative purposes only, and that many other sizes and shapes of the paint-return paint can device 100 are well within the scope of the present disclosure. Although the dimensions of the paint-return paint can device 100 are important design parameters for user convenience, the paint-return paint can device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A paint-return paint can device comprising:
a paint-removing member comprised of:
a body comprised of a fastener configured to engage a rim of a paint can;
a brush-engaging surface disposed on the body; and
an auxiliary paint removal element disposed on the body.

2. The paint-return paint can device of claim 1, wherein the fastener is comprised of a tab, a locking peg, a snap-fit element, or an interlocking tongue.

3. The paint-return paint can device of claim 1, wherein the brush-engaging surface is comprised of a ridge, a fin, a blade, or an angular protrusion.

4. The paint-return paint can device of claim 1, wherein the brush-engaging surface is comprised of a flat shape, a concave shape, or a convex shape.

5. The paint-return paint can device of claim 1, wherein the auxiliary paint removal element is comprised of a stipple, a dimple, a cross-hatching, an etched microgrooves, a molded rib, a raised channel, a flexible wiper flap, or a contour.

6. A paint-return paint can device comprising:
a container body having an interior space and a rim;
a lid; and
a paint-removing member positioned on the rim, the paint-removing member comprising:
a brush-engaging surface; and
an auxiliary paint removal element.

7. The paint-return paint can device of claim 6, wherein the brush-engaging surface is sloped at an angle between 1 and 89 degrees towards the interior space relative to a horizontal axis of the container body.

8. The paint-return paint can device of claim 6 further comprised of a handle assembly.

9. The paint-return paint can device of claim 8, wherein the handle assembly is comprised of a grip area.

10. The paint-return paint can device of claim 8, wherein the handle assembly is comprised of a texture.

11. The paint-return paint can device of claim 6, wherein the container body is comprised of a volumetric measurement indicator.

12. The paint-return paint can device of claim 6, wherein the paint-removing member is comprised of a first fastener.

13. The paint-return paint can device of claim 12, wherein the first fastener is comprised of a tab, a locking peg, a snap-fit element, or an interlocking tongue.

14. The paint-return paint can device of claim 6, wherein the lid is comprised of a receiving area.

15. The paint-return paint can device of claim 6, wherein the lid is comprised of a second fastener.

16. The paint-return paint can device of claim 6 further comprised of a lug.

17. The paint-return paint can device of claim 6, wherein the brush-engaging surface is comprised of a ridge, a fin, a blade, or an angular protrusion.

18. The paint-return paint can device of claim 6, wherein the brush-engaging surface is comprised of a flat shape, a concave shape, or a convex shape.

19. The paint-return paint can device of claim 6, wherein the auxiliary paint removal element is comprised of a stipple, a dimple, a cross-hatching, an etched microgrooves, a molded rib, a raised channel, a flexible wiper flap, or a contour.

20. A method of using a paint-return paint can device, the method comprising the following steps:
providing a paint-return paint can device comprised of a container body having an interior space, a rim, and a paint-removing member;
pouring a liquid substance into the interior space;
brushing a paintbrush against the paint-removing member; and
sealing the container body by aligning the lid with the rim such that a receiving area of the lid corresponds with the paint-removing member.
